(19) United States
(12) Patent Application Publication
(10) Pub. No.: US 2010/0125911 A1
(43) Pub. Date: May 20, 2010

(54) Risk Scoring Based On Endpoint User Activities

(76) Inventor: Prakash Bhaskaran, Banglore (IN)

Correspondence Address: Ashok Tankha, 36 Greenieigh Drive, Sewell, NJ, 08080, US

(21) Appl. No.: 12/487,649

(22) Filed: Jun. 19, 2009

(30) Foreign Application Priority Data
Nov. 17, 2008 (IN) 2826/CHE/2008
Apr. 22, 2009 (IN) 933/CHE/2009

(51) Int. Cl. G06F 21/00; G06F 3/048; G06F 17/00

(52) U.S. Cl. 726/23; 726/1; 715/781

(57) ABSTRACT

Disclosed herein is a computer implemented method and system for ranking a user in an organization based on the user's information technology related activities and arriving at an end risk score used for determining the risk involved in activities performed by the user and for other purposes. Group risk ranking profiles and security policies for usage of the organization's resources are created. The user is associated with one or more group risk ranking profiles. A security client application tracks the user's activities. Points are assigned to the user's tracked activities based on each of the associated group risk ranking profiles. The assigned points are aggregated to generate a first risk score. The assigned points of the user's tracked activities are modified at different levels based on predefined rules. The modified points are aggregated to generate the end risk score which is used for compliance and governance purposes, optimizing resources, etc.

### CROSS REFERENCE TO RELATED APPLICATIONS

The following patent applications are incorporated herein in their entirety:
1. This application claims the benefit of non-provisional patent application number 933/CHE/2009 titled “Risk Scoring Based On Endpoint User Activities”, filed on Apr. 22, 2009 in the Indian Patent Office.
2. Non-provisional patent application number 2826/CHE/2008 titled “Activity Monitoring And Information Protection”, filed on Nov. 17, 2008 in the Indian Patent Office.
3. Non-provisional patent application Ser. No. 12/352,604 titled “Activity Monitoring And Information Protection”, filed on Jan. 12, 2009 in the United States Patent and Trademark Office.

### BACKGROUND

The computer implemented method and system disclosed herein, in general, relates to compliance management. More particularly, the computer implemented method and system disclosed herein relates to assigning an end risk score to a user's activities on desktops and other endpoints where security policies of an organization are enforced, determining level of compliancy of the user with the security policies, and identifying violations of the security policies.

Data protection is an essential aspect of an organization for maintaining data integrity. Typically, organizations maintain a large number of desktops, different databases, and servers. The desktops, databases, and servers store sensitive and confidential data. Different employees of an organization have variable access to the sensitive and confidential data over a corporate network of the organization. Trusted employees are often granted access to the sensitive and confidential data after a simple authentication with a user name and password combination. Once the employee accesses the data and downloads the data locally, the data becomes vulnerable to accidental, unintentional, or malicious leakage.

An organization typically creates security policies for employees regarding use of information technology (IT) resources of the organization. The security policy resides across the organization, for example, on workstations, servers, databases, the internet, intranets, etc. The security policies are created in an attempt to protect sensitive and confidential corporate and customer data and to prevent data leakage. However, enforcing such security policies is difficult, especially at desktops, because activities of every employee or user of the IT resources need to be continually monitored to ensure that the employee is not causing any data leakage. The activities need to be checked to ensure compliance with the security policies. To begin with, monitoring the user activities is a difficult task and continual monitoring produces enormous amount of data across the organization making the task of administrators even more difficult in identifying the violations by the user. Additionally, such monitoring does not quickly provide information on the intent of the user if the activities are not analyzed for specific behavioral patterns, as opposed to reading the activities chronologically.

The organizations typically monitor individual activities of the user to ensure that the user is not compromising the security of the organization's data. Certain activities are flagged as being dangerous, and when the user performs any of the flagged activities, the organization is alerted. However, with easy access to removable storage devices, electronic mail (email), instant messaging, screenshots of data, etc, it is easy for the user to cause leakage of data by performing a series of seemingly innocuous unflagged activities. The monitoring systems fail to recognize any danger to the data because the individual activities involved in the series are not regarded as dangerous. The organizations use different point solutions to monitor the corporate network, system changes, file activities, web and email activities, but the organization cannot identify the risks posed by the users' behavior.

Furthermore, by monitoring the individual activities in isolation and by various point solutions, the monitoring systems fail to identify the users who pose a high danger risk to the integrity of the sensitive and confidential data. Furthermore, different employees of the organization have different job descriptions, and hence different IT usage requirements. Hence, different users need to be assigned different risk ranking profiles. To assess the risk involved in the IT usage of each of the users, a risk score needs to be assigned to each of the users, so that the risk score assigned to each user can later be used by the organization for compliance purposes, governance purposes, optimizing resources, etc.

Hence, there is an unmet need for determining risk involved in activities performed by a user of resources of an organization on a computing device, determining compliance with the security policies, and identifying violations of the security policies.

### SUMMARY OF THE INVENTION

This summary is provided to introduce a selection of concepts in a simplified form that are further described in the detailed description of the invention. This summary is not intended to identify key or essential inventive concepts of the claimed subject matter, nor is it intended for determining the scope of the claimed subject matter.

The computer implemented method and system disclosed herein addresses the above stated need for determining risk involved in activities, for example, information technology (IT) activities performed by a user of resources of an organization at desktops and other endpoints, for determining compliance with the security policies, and for identifying violations of the security policies. The user performs IT related activities, for example, at desktop computers, laptop computers, handheld computers, mobile computing devices, and other endpoints. Multiple group risk ranking profiles and the security policies for usage of the IT resources of the organization are created. Each of the created group risk ranking profiles defines degree of risk for activities performed by users based on the user groups the user belongs to. Each of the group risk ranking profiles comprises, for example, a threshold range or a threshold value of risk for each of the user groups. The security policy comprises a predefined list of online resources accessible by the user and a predefined list of actions the user may perform on the information and on the computing device while accessing the information.

The user is associated with one or more group risk ranking profiles. A security client application is provided on a computing device of the user. The security client application tracks activities of the user in the organization. The tracked activities are reported back to a risk management server via a network. The security client application is used to enforce the security policies of the organization by preventing users from performing activities disallowed to the users by the security policies. An end risk score for the user is dynamically generated for each of the associated group risk ranking profiles as follows: a time frame is selected for generating an end risk score for the user. Points are assigned to the tracked activities of the user based on each of the associated group risk ranking profiles. The assigned points are aggregated to generate a first risk score, for example, based on individual and independent user activities. Multiple predefined rules specified in the group risk ranking profiles are applied to the tracked activities. The predefined rules are, for example, associated with the type of the tracked activities, sequence of the tracked activities, patterns of the tracked activities within a time frame, date and time of the tracked activities, and quantity and type of data or files associated with the tracked activities. The assigned points of the tracked activities of the user are modified at different levels based on the predefined rules.

The modification of the assigned points at different levels comprises, for example, modification at a first level based on the chronological sequence of the tracked activities or a certain pattern of the tracked activities within a time frame, modification at a second level based on the date and time of the tracked activities, and modification at a third level based on the quantity and type of the data or files associated with the tracked activities. The modified points are aggregated to generate the end risk score for the selected time frame. The predefined rules are modifiable by an administrator of the organization. By parsing the same set of tracked activities using the modified rules, a different set of scores can be dynamically generated for the same activities. The generated end risk score determines the risk involved in activities performed by the user in the organization.

The generated end risk score of the user is, for example, used for identifying violations of the security policies of the organization by the user. The generated end risk score of the user is compared with the threshold range of the associated group risk ranking profiles for identifying the violations of the security policies by the user. Deviation of the generated end risk score of the user from one or more previously generated end risk scores of the user for the selected time frame is also calculated. The calculated deviations are used for identifying violations of the security policies by the user or to alert an administrator about changes in usage patterns by the user.

The user's end risk score are compared with the end risk score of a second user in the user group or compared with an average end risk score of a second user group. A report of the generated end risk score of the user for each of the associated group risk ranking profiles is created and displayed to an administrator. In one embodiment, the report is displayed as a dashboard interface to the administrator. The administrator uses the end risk score to modify the security policies enforced on the users to minimize further violations of the security policies. The tracked activities, the generated end risk score of the user, and the time frame for which the generated end risk scores are calculated are stored in a log database. The end risk scores enable the organization to chronologically identify the risks posed by the users' behavior and can later be used by the organization for compliance purposes, governance purposes, optimizing resources, etc.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and instrumentalities disclosed herein.

FIG. 1 illustrates a computer implemented method of determining risk involved in activities performed by a user of resources of an organization.

FIG. 2 illustrates a computer implemented system for determining risk involved in activities performed by a user of resources of an organization.

FIG. 3 exemplarily illustrates architecture of a computer system employed in a risk management server, and the computing device deployed with the security client application.

FIG. 4 exemplarily illustrates users of the organization connected to the risk management server via different networks.

FIG. 5 exemplarily illustrates a flow chart comprising steps of generating an end risk score of the user based on associated group risk ranking profiles.

FIG. 6 exemplarily illustrates a flow chart comprising steps of applying predefined rules to the tracked activities for generating an end risk score.

FIG. 7 exemplarily illustrates a block diagram comprising the types of the activities of the user tracked by the security client application.

FIG. 8 exemplarily illustrates a flow chart comprising different levels of modification of the assigned points for generating an end risk score of the user.

FIGS. 9A-9D exemplarily illustrate a sample group risk ranking profile for users of the operations department in an organization.

FIGS. 10A-10B exemplarily illustrate a user, Jack's historical activity log for a given time frame.

FIGS. 11A-11K exemplarily illustrate first modification of assigned points of the tracked activities of the user based on sequence or patterns of the tracked activities.

FIG. 12A exemplarily illustrates a graphical representation of a comparison of a user's end risk score with the end risk scores of other users in the same group.

FIG. 12B exemplarily illustrates a graphical representation of a comparison of a user's present end risk score with the user's previous end risk scores.

FIGS. 13A-13B exemplarily illustrate a list of threshold ranges associated with the group risk ranking profiles of an organization and a department respectively.

### DETAILED DESCRIPTION OF THE INVENTION

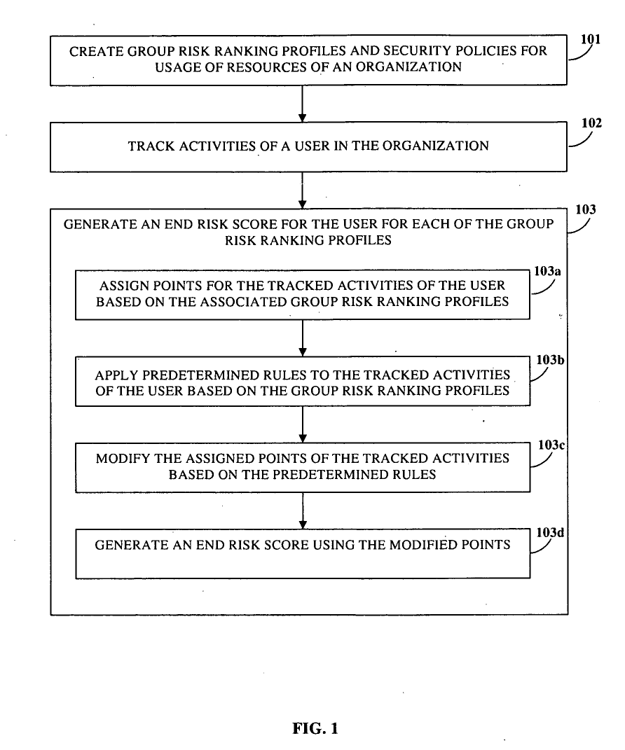

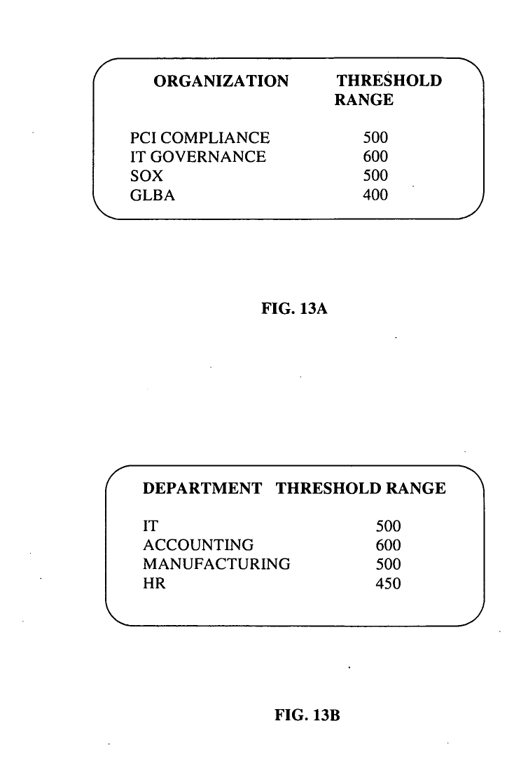

FIG. 1 illustrates a computer implemented method of determining risk involved in activities performed by a user of resources, for example, information technology (IT) resources of an organization. The user performs IT related activities, for example, at desktop computers, laptop computers, handheld computers, mobile computing devices, and other endpoints in the organization. The organization comprises multiple second users in different departments of the organization. Multiple group risk ranking profiles and security policies for usage of the resources of the organization are created 101. The group risk ranking profiles and the security policies are created independent of each other. Each of the created group risk ranking profiles defines the degree of risk of activities performed by users based on the user groups the user belongs to. The group risk ranking profile comprises, for example, information on risk associated with activities of the user based on the user's department or role in the organization, the organization's IT governance, etc. Each of the group risk ranking profiles comprises, for example, a threshold range or a threshold value of risk for each of the user groups, as exemplarily illustrated in FIGS. 13A-13B.

The security policies comprise definitions and rules to be followed by the users in the organization enforced by the security client application. The security policy comprises a predefined list of online resources accessible by the user and a predefined list of actions the user performs on the information and on the computing device while accessing the information. In a multiple user environment, each user's security policy is based on a user group that the user belongs to as configured in the policy server. For example, in a corporate environment, the security policy for each of the users is determined by a policy server based on the position of the user in the corporate environment, job profile of the user, etc.

The user is associated with one or more of the group risk ranking profiles. For example, the user may be associated with a group risk ranking profile 1 based on type of department, for example, the information technology department, in the organization. The same user may also be associated with group risk ranking profile 2 based on the role of the user in the organization. Each of the users in the organization may belong to a group risk ranking profile to identify the violators of payment card industry (PCI) compliance or Sarbanes-Oxley Act of 2002 (SOX) compliance as per the requirements of the entire organization as a whole. A security client application is provided on the computing device of the user. For purposes of illustration, the detailed description refers to a single user in the organization; however the scope of the computer implemented method and system disclosed herein is not limited to a single user but applies to multiple second users in the organization provided with security client applications on the users' respective computing devices. The security client application tracks 102 the activities of the user in the organization. The security client application also tracks and reports all user activities to a risk management server in the corporate network, along with other details such as user name, computer name, time and date of activity, etc.

In one embodiment, the security client application is embedded within a local software component on the computing device if the computing device connects to the organization's corporate network via a virtual private network (VPN) connection or the internet via a web browser. In a second embodiment, the security client application and the local software component run independently as separate standalone applications in the computing device if the activities are performed within the corporate network. In a third embodiment, the local software component is embedded within the security client application. The computing device is, for example, a personal computer, mobile phone, a personal digital assistant, a laptop, a palmtop, etc. The local software component is preloaded on the computing device or runs directly from a remote location within a corporate network of the organization.

The local software component is, for example, a web browser, a virtual private network (VPN) client, an electronic mail (email) client, a database administrator tool, a database client application, etc., or any software component that accesses information via a network, for example, the internet or an intranet, or on a desktop computer, and functions in a client server model. The local software component may be any software component that accesses information via a network. As used herein, the term “software component” refers to a system element offering a predefined service or event, and able to communicate with other components. The local software component may be a stand-alone software application, or a software element typically running in context of another software application, for example, an ActiveX™ control, a Java™ applet, a Flash™ object, etc. The local software component may also be preconfigured to connect with specific remote corporate computers. The user provides login credentials to the security client application for authentication by a policy server. Alternatively, the policy server may contact a remote corporate server for the authentication. The security client application queries the policy server for a security policy for the user on receiving a request for access to the information from the user. The security client application then enforces the security policies of the organization on the computing device.

In case of a standalone software application, if the computing device is being used outside the corporate network, for example, a laptop computer being used at the user's home, the security client application continues to collect the user activity information and saves the collected user activity information locally. The security client application reports the saved user activity information to the risk management server once the computing device returns to the corporate network.

The security client application tracks every activity performed by the user on the computing device. The activities tracked comprise, for example, accessing information stored in the computing device, copying whole or part of the accessed information, modifying a locally or remotely stored file, copying the stored file, use of removable storage media, network connections by various applications currently running, bandwidth usage, printing and electronically transmitting the accessed information, etc. The tracked activities further comprise use of electronic mails, peer to peer applications, web uploads, web downloads, changes to system configuration, use of removable storage devices, clipboard activities, print and screenshot activities, file sharing activities, keyboard usage, mouse click events, etc.

An end risk score is dynamically generated 103 for the user for each of the associated group risk ranking profiles. For generating the end risk score, the tracked activities of the user are assigned 103a points for individual activities based on each of the associated group risk ranking profiles. The assigned points are aggregated to generate a first risk score. Predefined rules are applied 103b to the tracked activities. The assigned points of the tracked activities of the user are modified 103c at different levels based on the applied predefined rules. The modified points obtained after application of the rules override the generated first risk score. At each level of application of the rule, a different score is obtained. The predefined rules are applied differently to different tracked activities. The predefined rules are, for example, associated with the type of the tracked activities, sequence or patterns of the tracked activities, date and time of the tracked activities, quantity and type of data or files associated with the tracked activities, etc.

Consider, for example, three levels of modification of the risk scores as the user activities are processed at the risk management server: a first level modification, a second level modification, and a third level modification, based on the sequence or patterns of tracked activities or certain pattern of activities in a time frame, the date and time of the tracked activities, and the quantity of data associated with the tracked activities respectively. In the first level modification, the assigned points of the tracked activities are modified based on a particular sequence or patterns of activities to generate a second risk score. For example, if the user performs one or more of a set of predefined sequence or patterns of activities, the user is assigned a different set of points than if each of the activities were performed individually. The predefined sequences or patterns of activities are stored in a rule database as part of the group risk ranking profiles. The points assigned to the individual activities that appear in the predefined sequence or patterns are replaced with points allotted to that particular predefined sequence or patterns of activities.

In the second level modification, the assigned points of the tracked activities are modified again based on the date and time of the tracked activities to generate a third risk score. For example, if the user performs the activities over a weekend, the user is given a different set of points than if the user performs the activities on weekdays. In the third level modification, the points of the tracked activities are modified based on the quantity and type of data and files associated with the tracked activities to generate a fourth risk score. For example, if the user copies 20 files from a desktop to a universal serial bus (USB) storage device, the user will be given a different set of points than the sum of the points for each file copied. If the user copies an email folder, for example, a “pst” file, into the storage device, a different set of points is assigned due to the type of file copied. After a set of activities is passed through the three levels of modifications based on the predefined rules, the end risk score is generated 103d for the user based on the group risk ranking profile of the user group that the user belongs to. The modified points are aggregated to generate the end risk score. The end risk score is dynamically generated for a selected time frame. The user is given different end risk scores for the same tracked activities, if the user is associated with multiple group risk ranking profiles.

The administrator in the organization may select a different time frame for generating the end risk score of the user. The time frame is, for example, in hours, days, months, years, etc. Therefore, the end risk score can be generated for activities performed in the preselected time frame in hours, days, months, years, etc. The end risk score is generated for the selected time frame, for example, from January to March, from 8 a.m. to 6 p.m. of a work day, etc. The generated end risk score determines the risk involved in the activities performed by the user in the organization. The generated end risk score of the user is used for identifying the violations of the security policies of the organization. The generated end risk score enables easy identification of the users in an organization who need to be monitored, mentored, trained, or terminated so that the users remain in compliance with the organization's IT and security policies and reduce overall organizational risk.

The generated end risk score are used in different ways for identifying violations of the security policies. For example, the end risk score of the user is compared with the threshold range of each of the associated group risk ranking profiles for identifying the violations and deviations from the security policies by the user. The comparison helps in quickly identifying one user's risk level compared to other users in the same user group. If the end risk score exceeds the threshold, an alert may be sent to an administrator in the organization. Deviation of the generated end score of the user from one or more previously generated end risk scores of the user is calculated for a selected time frame for identifying the violations of the security policies by the user. The deviation may be computed using multiple previously generated end risk scores over a time frame or an average of the previously generated end risk scores over the time frame. The end risk scores enable the organization to chronologically identify the risks posed by the users' behavior and can later be used by the organization for compliance purposes, governance purposes, optimizing resources, etc.

The generated end risk scores enable easy identification of violators of the organization's IT policies. For example, if the organization deals with credit card information of customers, the organization has to be in compliance with the payment card industry (PCI). A group risk ranking profile can quickly be created with few rules that identify users violating the PCI compliance requirements. The group risk ranking profile in this case will comprise rules to identify users who send emails with attachments containing credit card or personally identifiable information (PII) in an unencrypted format. By running the user activities through the group risk ranking profile, the administrator is enabled to quickly identify the violators.

The end risk scores are also used to monitor users so internet usage can be optimized. In this case, a group risk ranking profile can be created with rules to assign points to users using a web browser to visit non-business related web sites. A list of business related and non-business related web site uniform resource locator (URL) list can be maintained at the risk management server. By generating end risk scores using the group risk ranking profile, the violators are identified. The administrators may then perform corrective actions to optimize internet usage by the users.

The end risk scores are further used to determine users who copy certain types of files into USB devices. For example, when the user copies a file to a USB device, the individual activity of copying the file to the USB device in the first level of scoring obtains 10 points. However, if the file copied to the USB device is, for example, a Microsoft Outlook™ email storage file, 500 points are assigned in the second level of scoring based on the predefined rules. The end risk scores may be used in many other ways to optimize usage of IT and other corporate resources in the organization and minimize risk of data leaks.

A report comprising the generated end risk scores the user in each of the group risk ranking profiles is created and displayed to an administrator. In one embodiment, the report is displayed on an interactive dashboard interface to the administrator. The interactive dashboard interface comprises top scores for each of the group risk ranking profiles. The dashboard interface is implemented on a graphical user interface (GUI). The tracked activities, the different risk scores, the generated end risk scores of the user, and the time frame for which the generated end risk scores are calculated, are stored in a log database. A report is created for each of the users in the organization. The generated end risk scores of each of the users may be plotted as a graph for selected time frames and displayed to the administrator for identifying the top violators of the security policies in the organization. The organization may perform remediation on identified violating users, for example, by training, mentoring, or termination. The generated end risk score is also used to train the user to optimize the use of the resources of the organization. Furthermore, the generated end risk score of the user is also used to fix broken business processes of the organization.

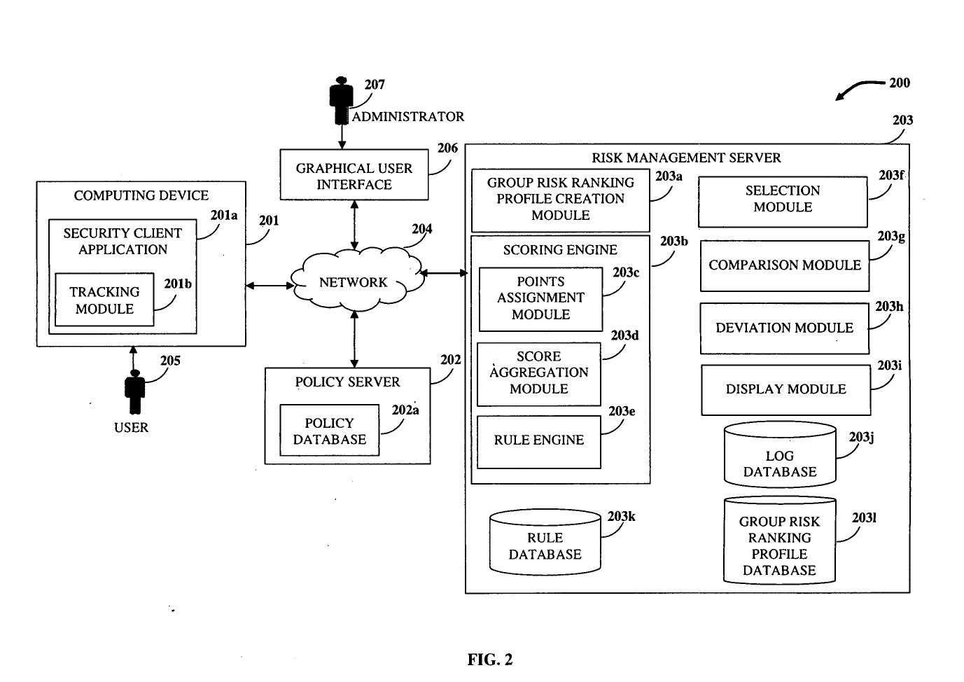

FIG. 2 illustrates a computer implemented system 200 for determining the risk involved in activities performed by a user 205 of resources of an organization. The computer implemented system 200 disclosed herein comprises a security client application 201a, a risk management server 203, a policy server 202, and a graphical user interface (GUI) 206 connected to each other via a network 204.

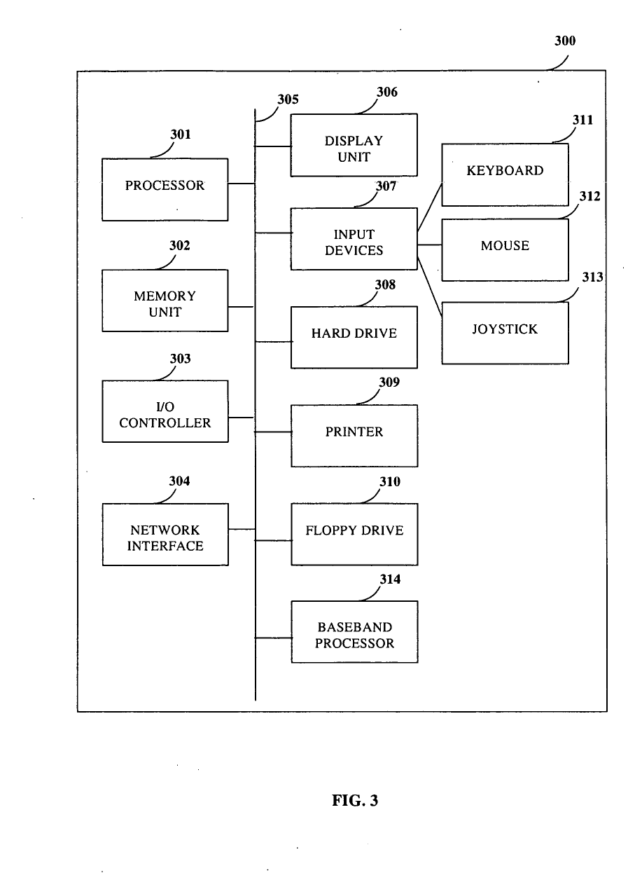

The security client application 201a is provided on the computing device 201 of the user 205. The computing device 201 is, for example, used by the user 205 at desktops and other endpoints. The security client application 201a comprises a tracking module 201b. The tracking module 201b tracks activities of the user 205 in the organization. The computing device 201 comprises, for example, a computer system 300. The computer system 300 employed for installing the security client application 201a on the computing device 201 is exemplarily illustrated in FIG. 3. The tracking module 201b tracks activities of the user 205 performing multiple activities on the computing device 201. The activities comprise accessing information from the network 204, for example, via the internet 403 or via an intranet. The user 205 accesses information via the internet 403, for example, through web or a virtual private network (VPN). The user 205 access information via the intranet, for example, through the web 201, desktop 201, laptop 201, etc. The user 205 also performs other activities, for example, copying files to and from USB devices, printing data, performing clipboard activities, etc.

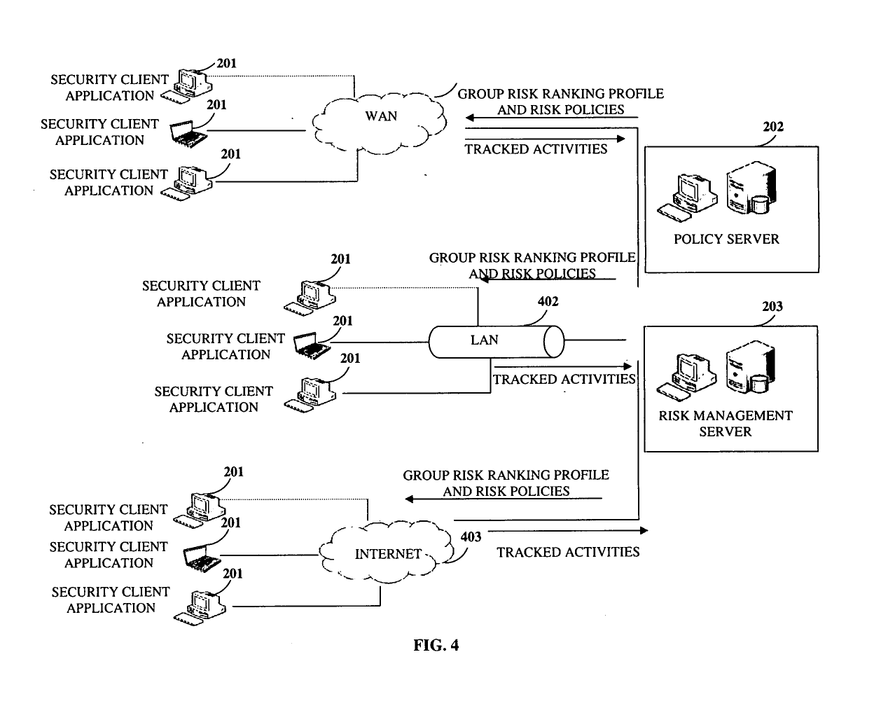

The tracking module 201b also tracks behavioral activities of the user 205. The behavioral activities comprises, for example, use of keyboard, mouse click events, printing, taking screen shots, inserting USB storage devices, launching applications, sending emails, sending or receiving files using instant messengers, etc. Multiple users in the organization are connected to the risk management server 203 via different networks 204, for example, a local area network (LAN) 402, a wide area network (WAN) 401, or the internet 403 as exemplarily illustrated in FIG. 4.

The risk management server 203 comprises a group risk ranking profile creation module 203a, a scoring engine 203b, a comparison module 203g, a deviation module 203h, a selection module 203f, a display module 203i, a log database 203j, a rule database 203k, and a group risk ranking profile database 203l. The group risk ranking profile creation module 203a creates multiple group risk ranking profiles and the security policies for usage of the resources of the organization. The group risk ranking profile creation module 203a creates the group risk ranking profiles and the security policies independently of each other. The group risk ranking profile database 203l stores the created group risk ranking profiles. An administrator 207 in the organization may set up the group risk ranking profiles and the security policies through the GUI 206. The scoring engine 203b dynamically generates different risk scores, for example, a first risk score, a second risk score, and an end risk score for the user 205 for each of the associated group risk ranking profiles.

The scoring engine 203b comprises a points assignment module 203c, a score aggregation module 203d, and a rule engine 203e. The points assignment module 203c assigns points to the tracked activities based on each of the associated group risk ranking profiles. The points assignment module 203c then modifies the assigned points of the tracked activities of the user 205 at different levels based on predefined rules. The points assignment module 203c, for example, performs a first level modification, a second level modification, and a third level modification based on sequence or patterns of the tracked activities, date and time of the tracked activities, and quantity of data associated with the tracked activities.

The rule engine 203e applies the predefined rules to the tracked activities. The rule engine 203e parses the predefined rules for enabling the points assignment module 203c to assign the points to the tracked activities. The predefined rules are, for example, associated with the type of the tracked activities, sequence or patterns of the tracked activities, predefined patterns of activities, date and time of the tracked activities, and quantity and type of data associated with the tracked activities. The predefined rules are stored in the rule database 203k. The score aggregation module 203d aggregates points assigned to the tracked activities of the user 205 and generates different risk scores, for example, a first risk score, a second risk score, a third risk score, an end risk score, etc.

The comparison module 203g compares the generated end risk score with the threshold range of the associated group risk ranking profiles for identifying the violations of the security policies by the user 205. The deviation module 203h calculates deviation of the generated end score of the user 205 from one or more previously generated end risk scores of the user 205 for identifying the violations of the security policies by the user 205.

The selection module 203f enables the administrator 207 to select a time frame using the GUI 206 for generating the end risk score of the user 205. In one embodiment, the GUI 206 is a web based interface. The score aggregation module 203d generates the end risk score for the selected time frame. The display module 203i displays a report comprising the generated end risk score of the user 205 for each of the associated group risk ranking profiles on the GUI 206. The log database 203j stores the tracked activities, the different risk scores, and the generated end risk score of the user 205.

The policy server 202 comprises a policy database 202a. The policy database 202a stores the security policies of the organization for users and user groups of the organization. The security client application 201a communicates information on the user identity and the computing device 201 of the user 205 to the policy server 202. The security client application 201a receives security polices from the policy server 202, for example, periodically, or on a demand basis. The security policy stored in the policy database 202a is enforced on the computing device 201 of the user 205 by the security client application 201a. The log database 203j receives information on the tracked activities of the user 205 from the security client application 201a.

FIG. 3 exemplarily illustrates architecture of a computer system 300 employed in the risk management server 203, and the computing device 201 deployed with the security client application 201a. The computing device 201 and the risk management server 203 is, for example, implemented on a desktop computer, a laptop computer, a handheld computing device, a mobile computing device, a personal digital assistant (PDA), a smart phone, etc. The computing device 201 is, for example, used by the user 205 at the desktops and other endpoints.

The computer system 300 comprises a processor 301, a memory unit 302, an input/output (I/O) controller 303, a network interface 304, network bus 305, a display unit 306, input devices 307, a hard drive 308, a floppy drive 310, a printer 309, etc. The processor 301 performs different mathematical and logical calculations. The memory unit 302 is used for storing programs and applications. The security client application 201a, for example, is stored on the memory unit 302 of the computer system 300. The I/O controller 303 controls the input and output actions performed by the user 205. The network interface 304 enables connection of the computer system 300 to a network 204. The network 204, for example, is the internet 403, a local area network (LAN) 402, a wide area network (WAN) 401, a cellular network, etc. In case of a mobile computing device, the network interface 304 connects the computing device wirelessly to the network 204. The mobile computing device further comprises a baseband processor 314 for processing communication functions and managing communication transactions with the network 204. The display unit 306 displays computed results to the user 205. The input devices 307, for example, a mouse 312, a keyboard 311, a joystick 313, etc. are used for inputting data into the computer system 300. The hard drive 308 stores data. The floppy drive 310 is an external storage device. The printer 309 is an output device used for converting data stored in the computer system 300 onto a hard copy. The programs are loaded onto the hard drive 308 and into the memory unit 302 of the computer system 300 via the floppy drive 310, universal serial bus (USB) device, etc. The mouse 312 is used for selecting options on the display unit 306.

The computer system 300 employs an operating system for performing multiple tasks. The operating system manages execution of the security client application 201a provided on the computer system 300. The operating system further manages security of the computer system 300, peripheral devices connected to the computer system 300, and network connections. The operating system employed on the computer system 300 recognizes keyboard inputs of the user 205, output display, files and directories stored locally on a hard drive 308. Different programs, for example, web browser, e-mail application, etc. initiated by the user 205 are executed by the operating system with the help of the processor 301, for example, a central processing unit (CPU). The operating system monitors the use of the processor 301.

Instructions for executing the security client application 201a are retrieved by the CPU from the program memory. Location of the instructions in the program memory is determined by a program counter (PC). The program counter stores a number that identifies the current position in the program of the security client application 201a. The instructions fetched by the CPU from the program memory after being processed are decoded. After processing and decoding, the instructions are executed. The instructions comprise, for example, tracking the activities of the user 205 in real time, transferring the tracked activities to the log database 203j via the network 204, etc.

The computer system 300 of the risk management server 203 typically employs the architecture as illustrated in FIG. 3. The computing device 201 is connected to the risk management server 203 via the network 204. The CPU of the computer system 300 employed in the risk management server 203 executes requests and instructions of the computing devices 201 connected to the risk management server 203 via the network 204. Instructions for coordinating working of the modules of the risk management server 203 are retrieved by the CPU from the program memory in the form of signals. The instructions fetched by the CPU from the program memory after being processed are decoded. After processing and decoding, the instructions are executed. The CPU comprises an arithmetic and logic unit for performing mathematical and logical operations on the instructions. The instructions comprise, for example, assignment of points to the tracked activities, modification of the assigned points, aggregation of the scores, etc. The output of the processor 301 comprising different risk scores are displayed to the administrator 207 on the display unit 306 of the computer system 300 of the risk management server 203. The administrator 207 and user 205 interact with the computer system 300 using the GUI 206 of the display unit 306.

FIG. 4 exemplarily illustrates users 205 of the organization connected to the risk management server 203 via different networks. The networks are, for example, a wide area network 401, a local area network 402, the internet 403, a VPN, etc. The security client application 201a is installed on the computing device 201 of the user 205. The tracked activities are transferred to the log database 203j in the risk management server 203 via the network 204. An administrator 207 of the organization can access the security policies and information on the group risk ranking profiles from the policy server 202 and group risk ranking profile database 2031 in the risk management server 203 respectively via the network 204. The network 204 comprises different topologies, for example, star topology, bus topology, ring topology, etc. The LAN 402 covers a small physical area, for example, home, office, small group of buildings, etc. The WAN 401 covers a wide geographical area of an organization, for example, a city, national boundaries, or the internet 403 which is a public network.

The security client application 201a, for example, requests for a VPN connection of the organization over the network 204. The request is routed via a router to a VPN server. The policy server 202 sends the security policies for the user 205 to the security client application 201a. The security policies for the user 205 are retrieved from the policy database 202a in the policy server 202. The security client application 201a receives the security policies and enforces the security policies. The organization's resources are, for example, a web server, a file server, an application server, a database server, or a combination thereof. The organization's resources host any application or information that is accessed via a VPN connection. The VPN server initiates the connection. The activities performed by the user 205 on the computing device 201 are tracked and sent to the risk management server 203 and stored in the log database 203j.

In one embodiment, the security client application 201a also uses the internet 403 for communicating with the policy server 202 and the risk management server 203 for retrieving the security policies via a web browser. Furthermore, the security client application 201a may work within the corporate network of the organization on desktop and laptop computers as a standalone application without integration with or depending on a local software client. The security client application 201a runs along with a local software application. Alternatively, the security client application 201a runs as an independent process on the computing device 201 and enforces the security policies and collects information about the user's 205 activities.

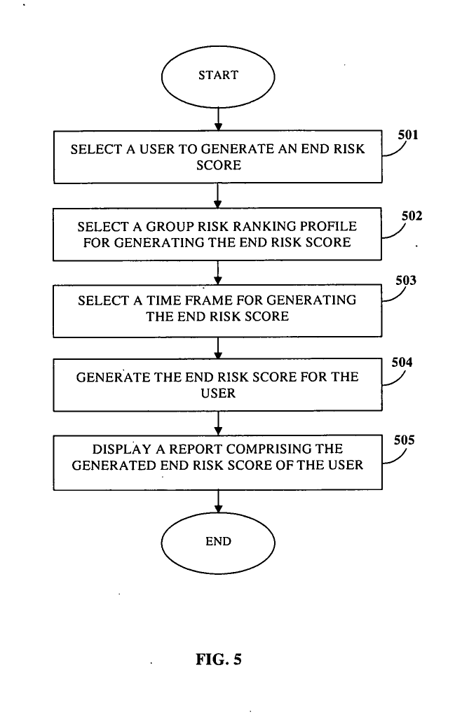

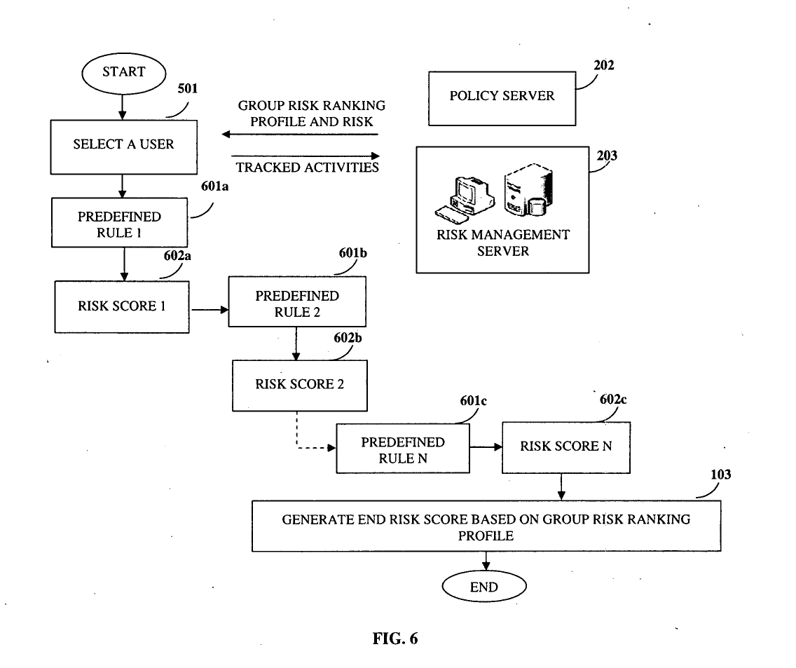

FIG. 5 exemplarily illustrates a flow chart comprising the steps of generating an end risk score of the user 205 based on associated group risk ranking profiles. Consider, for example, Danny who is an administrator 207 of an organization and Jack, who is an employee of the organization and a user 205 of the organization's IT resources. Danny wishes to know the degree of risk involved in Jack's usage of IT resources. Using the GUI 206, Danny first selects 501 Jack from a group of users. The security client application 201a is pre-installed on Jack's computing device 201 for tracking Jack's activities. Danny then selects 502 one of the group risk ranking profiles based on Jack's department, for example, the IT department. Danny then selects 503 a time frame of, for example, two weeks of tracked activities, for generating Jack's end risk score. Danny then requests the system 200 to generate 504 Jack's end risk score for the selected time frame. The generation of an end risk score from the first risk score is exemplarily illustrated in FIG. 6.

The security client application 201a tracks each of Jack's activities. In one embodiment, if Jack is accessing the corporate resources through VPN or the internet 403, then the security client application 201a is embedded into the local software component, i.e., the VPN client or the web browser. In another embodiment, if Jack performs activities while within the corporate network, the security client application 201a runs on his laptop or desktop computer without embedding on to a local software component. The security client application 201a and the local software component run independently of each other as standalone applications. In a third embodiment, the local software component is embedded within the security client application 201a. Once the security client application 201a identifies the Jack to the policy server 202, the policy server 202 sends the security policy to the security client application 201a. The security client application 201a then starts tracking Jack's activities and reports the tracked activities back to the log database 203j.

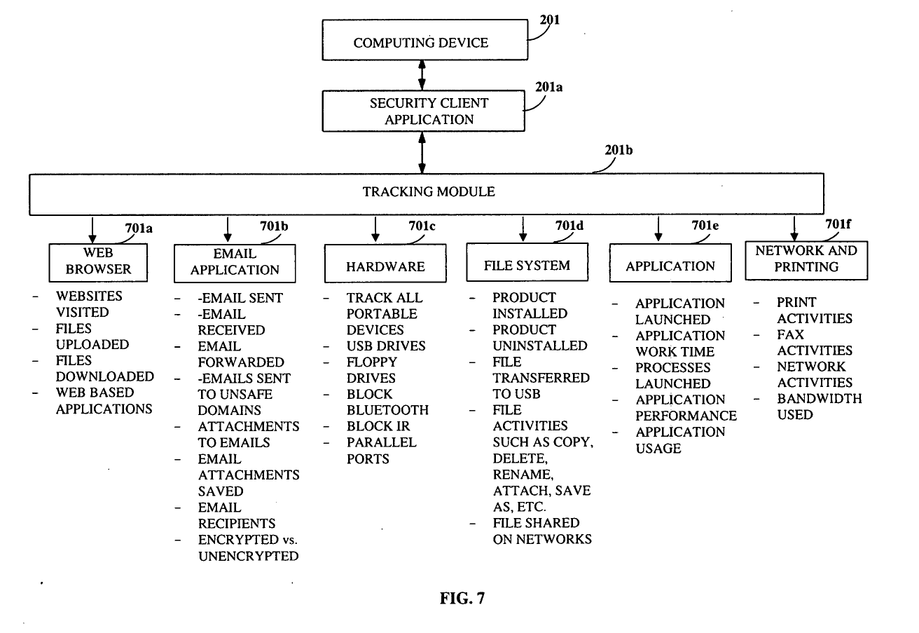

FIG. 7 exemplarily illustrates a block diagram comprising the types of the activities of the user 205 tracked by the security client application 201a. For purposes of illustration, FIG. 7 illustrates a predefined number of tracked activities; however the scope of the computer implemented method and system 200 disclosed herein is not limited to the activities illustrated in FIG. 7 but may be extended to include an almost unlimited number of activities performed by the user 205. The tracked activities are added, removed, or modified as per the requirements of the organization. The tracked activities comprise, for example, web browser activities 701a, email application activities 701b, hardware activities 701c, file system activities 701d, application activities 701e, network and printing activities 701f.

The web browser activities 701a comprise, for example, information on names of websites visited, files uploaded and downloaded, use of web based applications, etc. The email application activities 701b comprise, for example, information on email sent, email received, email forwarded, emails sent to unsafe domains, email attachments saved, recipients of the email, encrypted and unencrypted email attachments, etc. The hardware activities 701c comprise information on all activities on portable devices and ports such as universal serial bus (USB), floppy drives 310, Bluetooth™, infrared ports, parallel ports, etc. The file system activities 701d comprise information on products installed on the computing device 201, products uninstalled, USB file transfer, files copied, files deleted, files renamed, files attached, files saved, file sharing on the network 204, etc. The application activities 701e comprise information on names of the applications launched, application work time, processes launched, application performance, application usage, etc. The network and printing activities 701f comprise print activities, fax activities, network activities, including network connections opened by different applications on the computing device 201, along with upload and download bandwidth used by the applications. The activities tracked by the security client application 201a are not limited to the activities illustrated in FIG. 7. The security client application 201a tracks many other activities performed by the user 205 on the computing device 201.

The system 200 assigns 103a points to each of Jack's tracked activities based on predefined rules 601, for example, predefined rule 1 601a, predefined rule 2 601b, predefined rule N 601c, etc. and generates different risk scores 602, for example, risk score 1 602a, risk score 2 602b, and risk score N 602c, respectively as exemplarily illustrated in FIG. 6. The number of predefined rules and levels of modification is different for each instance of implementation. There may also be no predefined rules, in which case the first risk score is the end risk score.

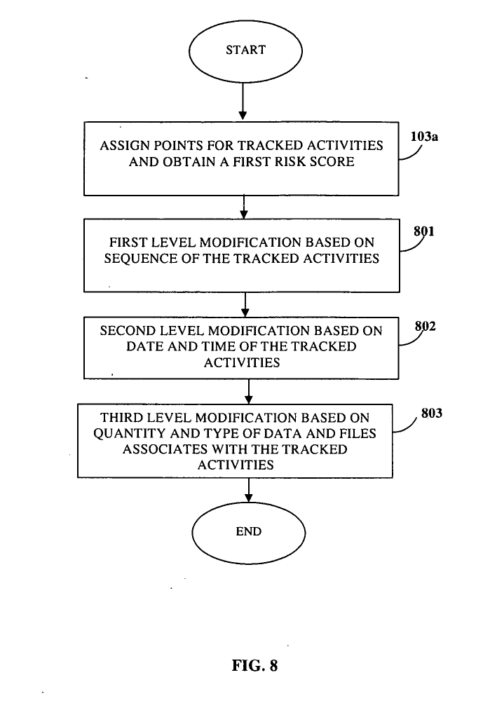

The assigned points of the tracked activities undergo a first level modification 801, as exemplarily illustrated in FIG. 8, based on the sequence or patterns of tracked activities to generate a risk score 2 602b, a second level modification 802 based on the date and time of the tracked activities to generate a third risk score, and a third level modification 803 based on the quantity and type of data and files associated with the tracked activities, as exemplarily illustrated in the flowchart of FIG. 8. Jack's end risk score is generated after different levels of modification.

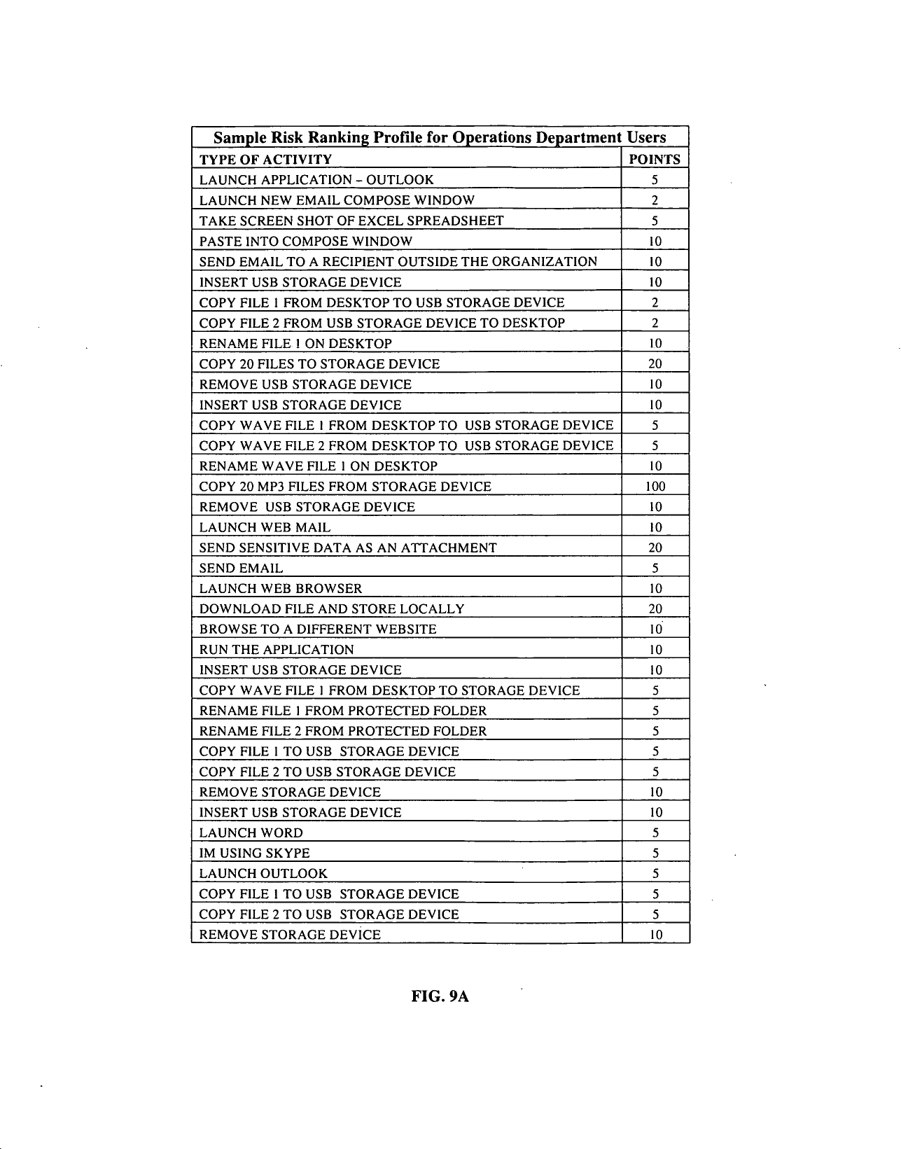

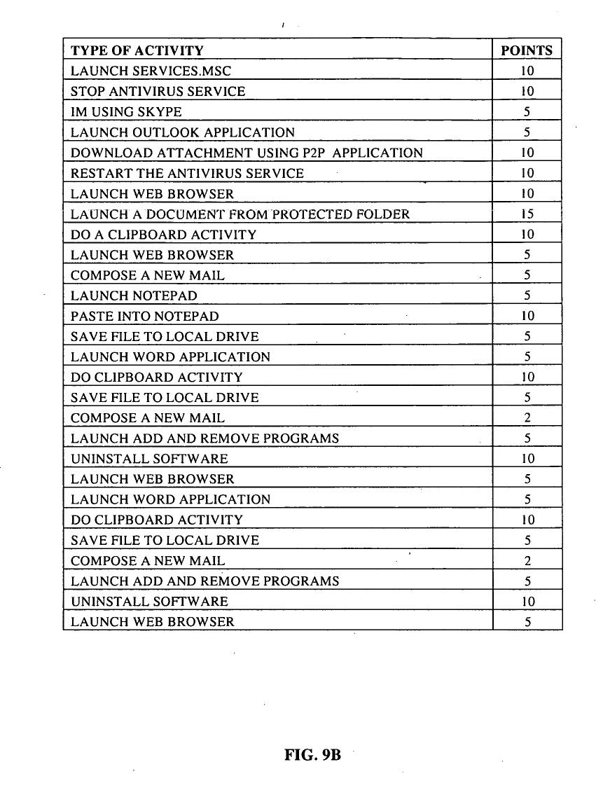

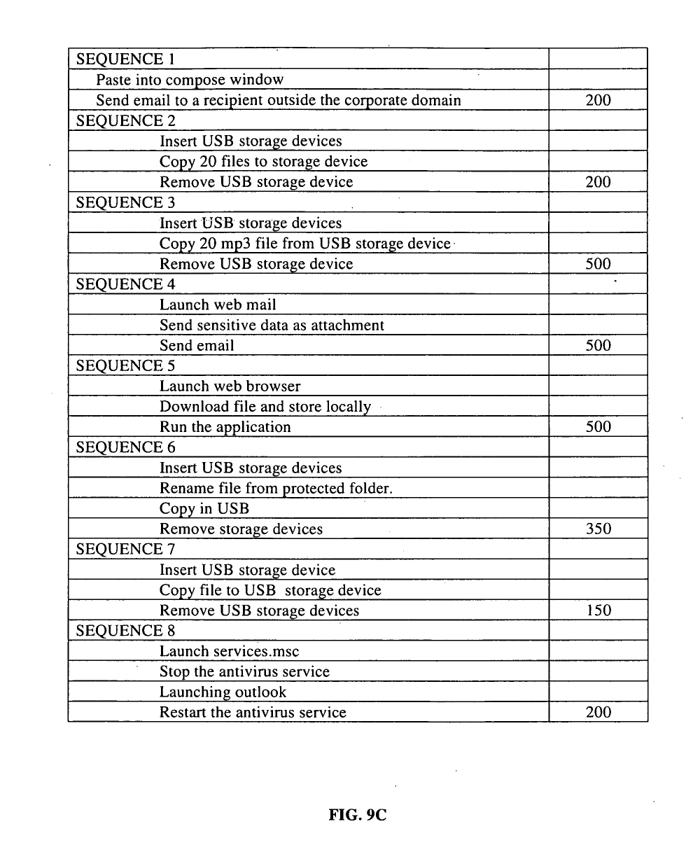

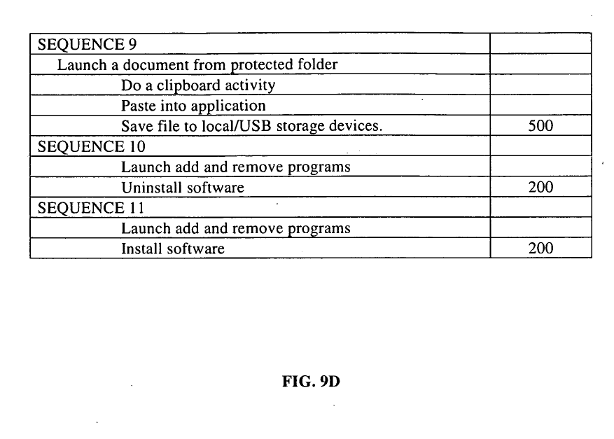

FIGS. 9A-9D exemplarily illustrate a sample group risk ranking profile for users of the operations department in an organization. The first level ranking based on individual activities of the user 205, along with the points assigned for each of the individual activities is illustrated in FIGS. 9A-9B. The second level ranking based on activity sequences or patterns, along with the points assigned for each of the activity sequences or patterns is illustrated in FIGS. 9C-9D.

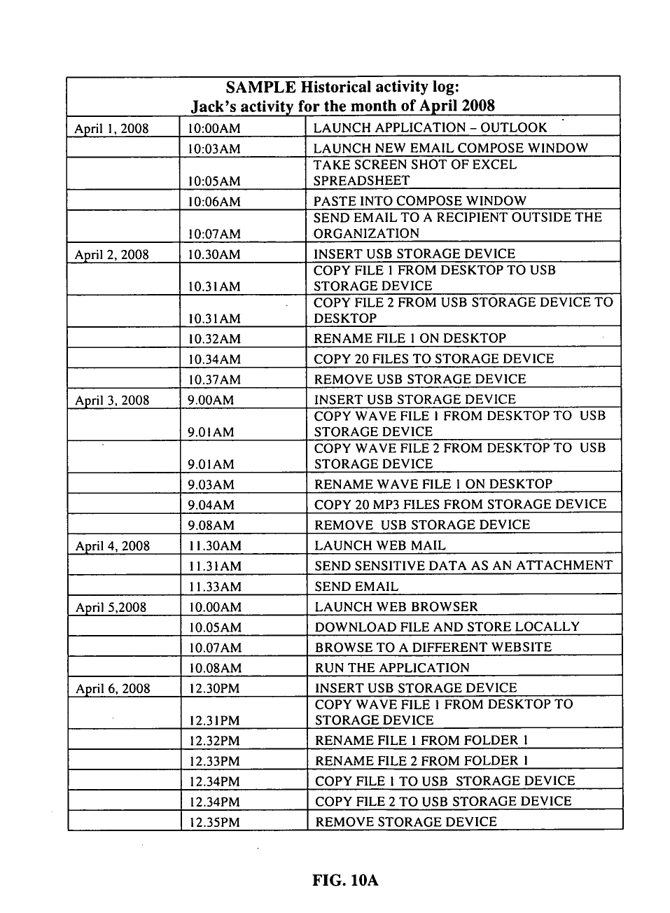

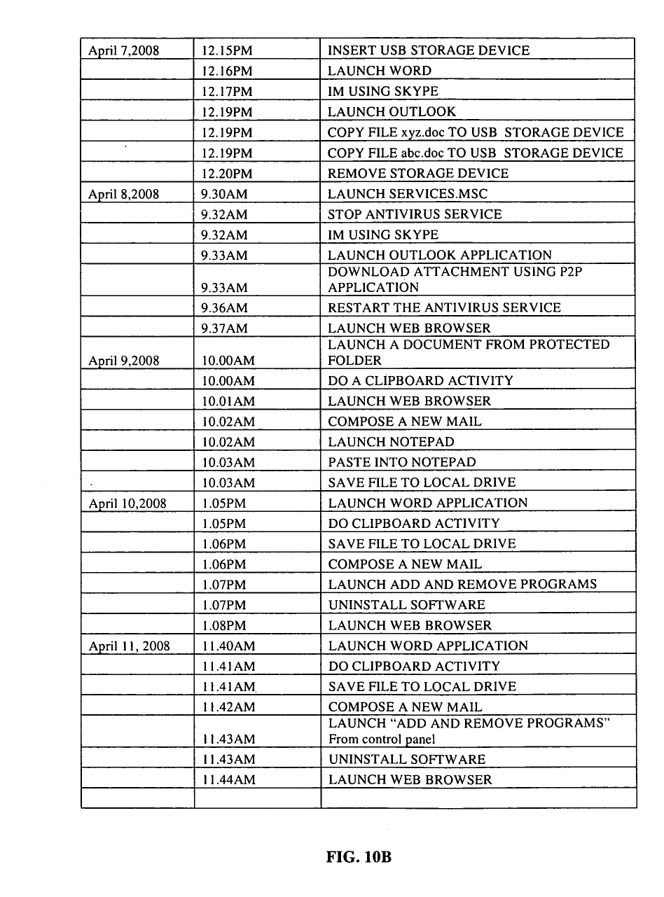

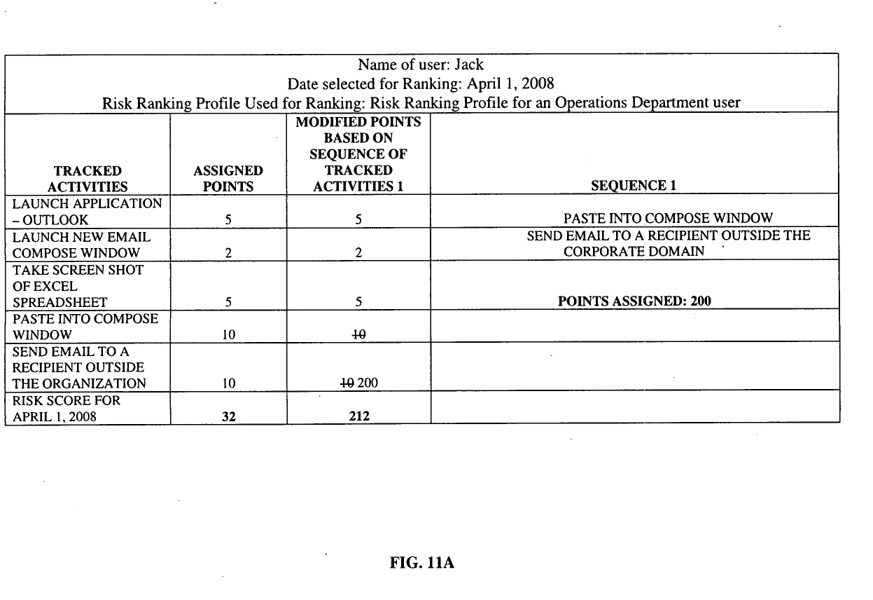

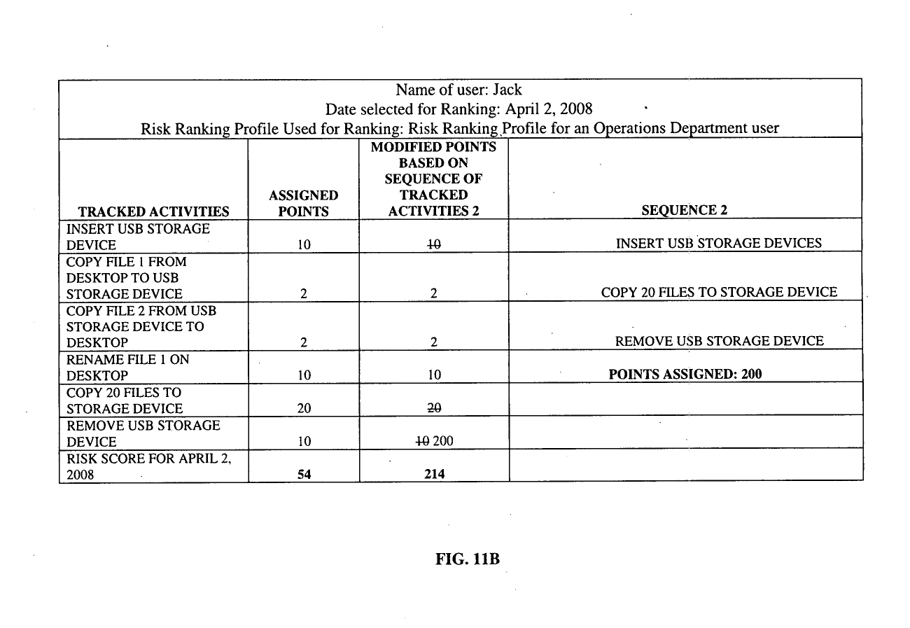

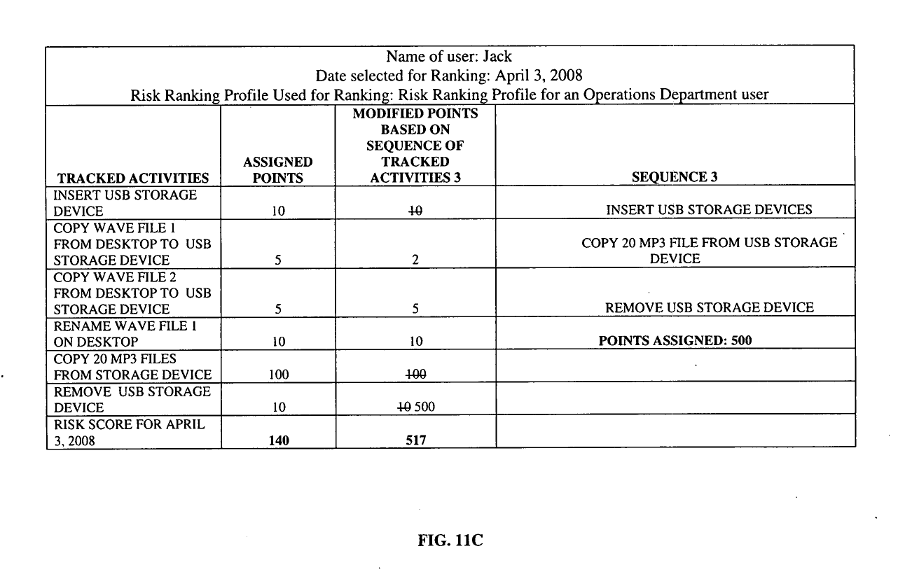

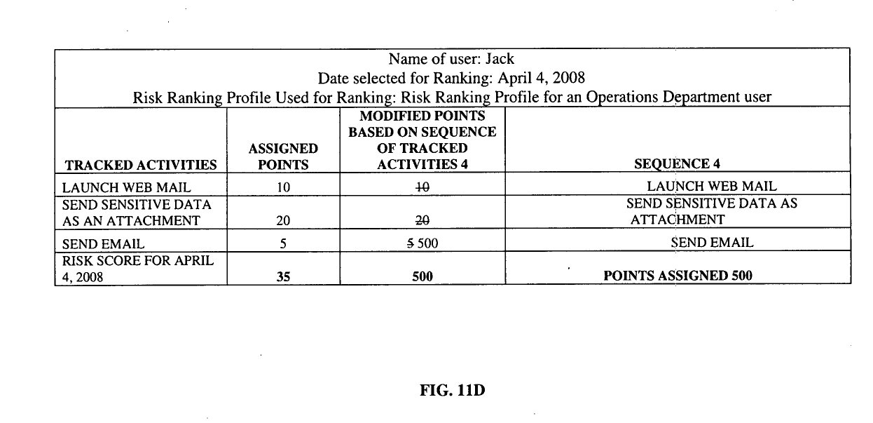

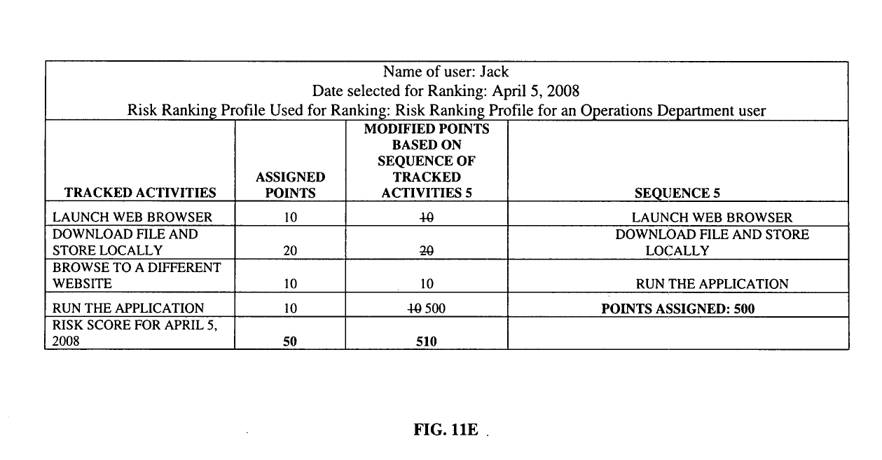

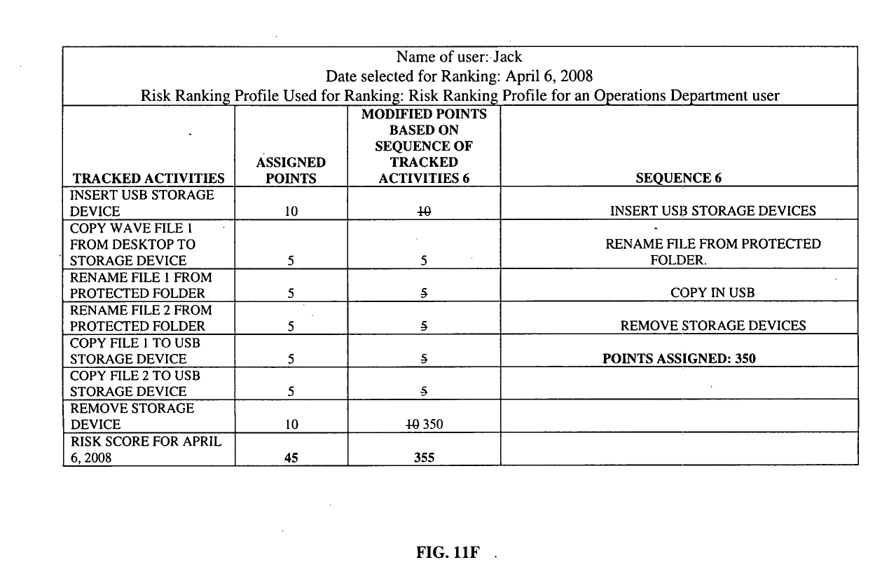

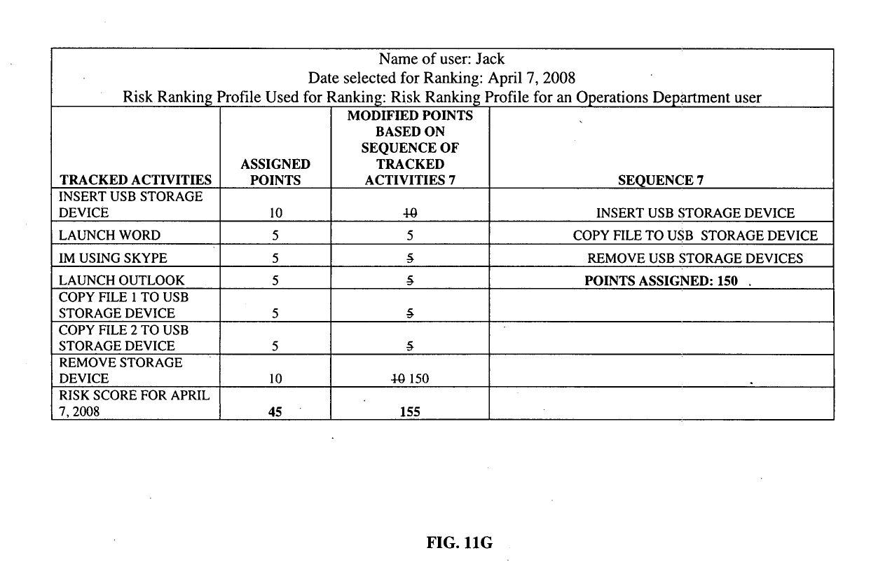

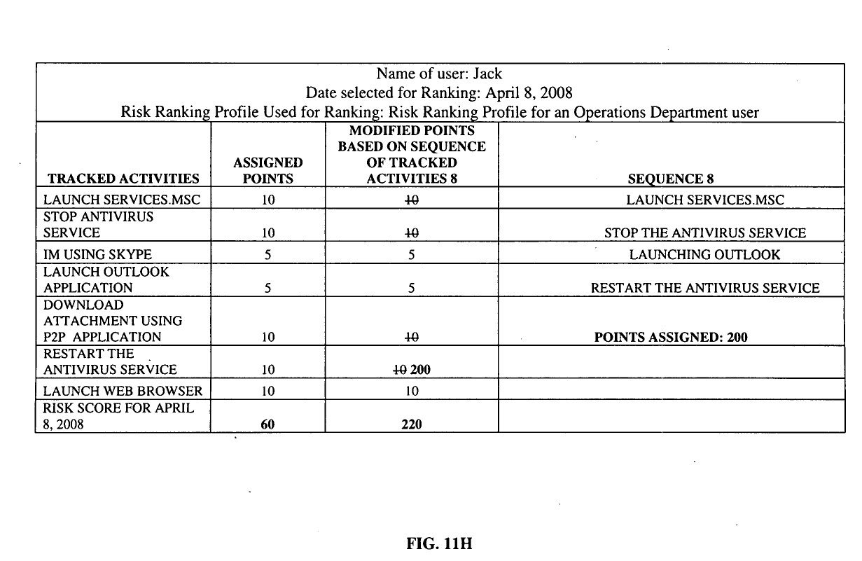

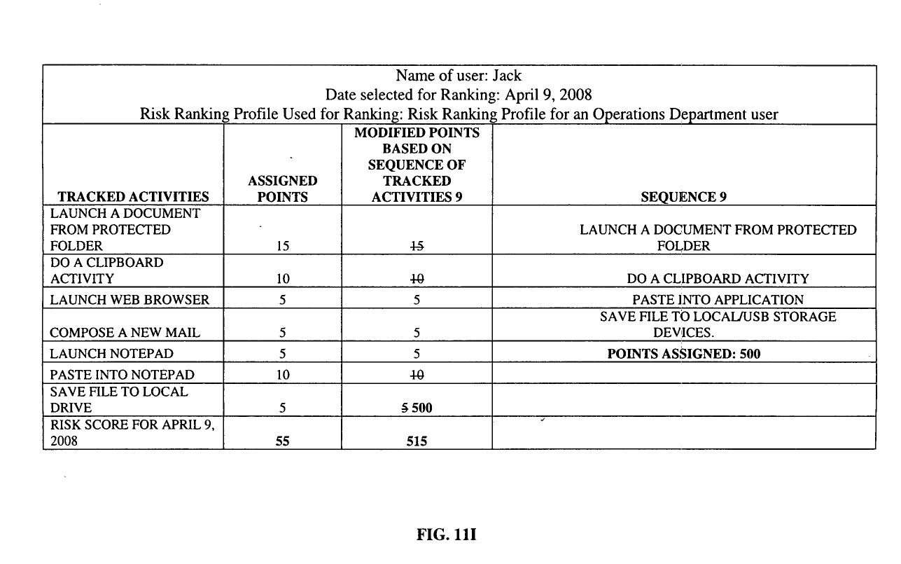

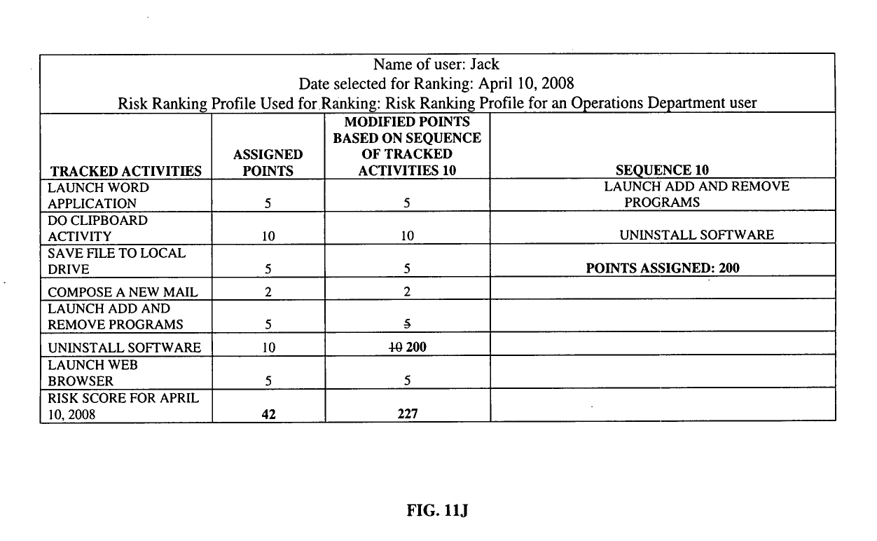

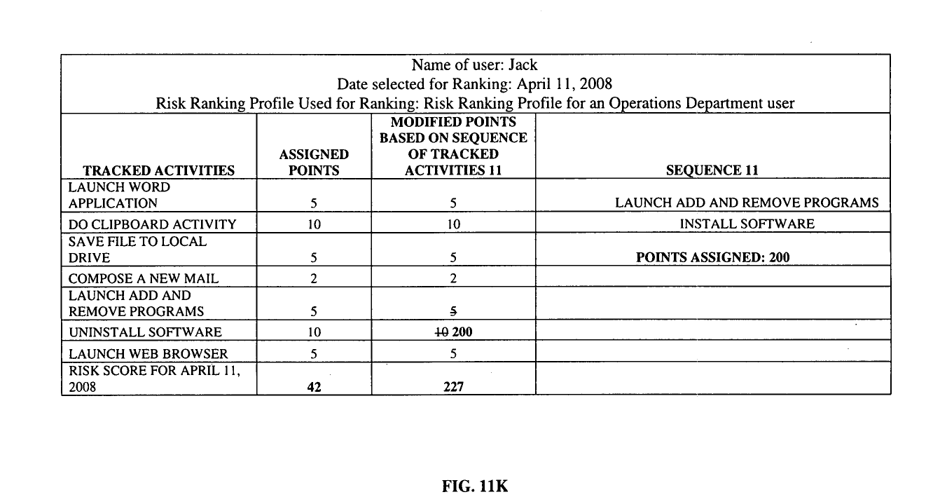

FIGS. 10A-10B exemplarily illustrates Jack's historical activity log for a given time frame. In FIGS. 10-10B, the given time frame is the month of April, 2008. The first risk scores assigned based on Jack's individual tracked activities and the first level modification 801 based on sequences or patterns of tracked activities is exemplarily illustrated in FIGS. 11A-11K.

Consider an example of Jack's tracked activities as illustrated in FIG. 11A. For Jack's activities on Apr. 1, 2008, Jack is assigned 5 points for launching an outlook application, 2 points for launching a new email compose window, 5 points for taking a screen shot of an excel spread sheet, 10 points for pasting the screen shot on the email compose window, and 10 points for sending the email to a recipient outside the organization. The risk score 1 602a of all the tracked activities is 32. The assigned points undergo a first level modification based on the sequence or patterns of the tracked activities to generate a risk score 2 602b.

As exemplarily illustrated in FIG. 9C, the sequence of pasting a screen shot on the email compose window and sending the email to the recipient outside the corporate domain form a predefined sequence of tracked activities sequence 1, that is assigned 200 points. Since there is a match between Jack's activities and the sequence 1, a first level modification is performed. Hence, Jack is assigned 200 points for the sequence and the individual points for pasting the screen shot on the email compose window and sending the email to a recipient outside the organization are canceled. The risk score 2 602b after the first level modification based on the sequence of tracked activities is 212, which overrides the earlier score of 32.

Consider another example of Jack's tracked activities as illustrated in FIG. 11B. For Jack's activities on Apr. 2, 2008, Jack is assigned 10 points for inserting a USB storage device, 2 points for copying file 1 from a desktop to the USB storage device, 2 points for copying file 2 from the USB storage device to the desktop, 10 points for renaming file 1 on the desktop, 20 points for copying 20 files to the USB storage device, and 10 points for removing the USB storage device. The risk score 1 602a of all the above tracked activities performed individually is 54. The assigned points undergo a first level modification based on the sequence of the tracked activities to generate the risk score 2 602b. As exemplarily illustrated in FIG. 9C, the activities insertion of USB storage device, copying 20 files to the USB storage device, and removal of the USB storage device form a predefined sequence and therefore Jack is assigned 200 points for the sequence. The risk score 2 602b after the first level modification based on the sequence of tracked activities is 214.

Consider another example of Jack's tracked activities as illustrated in FIG. 11C. For Jack's activities on Apr. 3, 2008, Jack is assigned 10 points for inserting a USB storage device, 5 points for copying a “wave file 1” from the desktop to the USB storage device, 5 points for copying “wave file 2” from the desktop to the USB storage device, 10 points for renaming the wave file 1 on the desktop, 100 points for copying 20 mp3 files from the USB storage device, and 10 points for removing the USB storage device from the desktop. The risk score 1 602a of all the above tracked activities performed individually is 140. The assigned points undergo a first level modification based on the sequence of the tracked activities to generate a risk score 2 602b. According to FIG. 9C, the activities insertion of the USB storage device, copying 20 mp3 files from the USB storage device, and removal of the USB storage device form a predefined sequence and Jack is assigned 500 points for the sequence. The risk score 2 602b after the first level modification based on the sequence of tracked activities is 517.

Consider another example of Jack's tracked activities as illustrated in FIG. 11D. For Jack's activities on Apr. 4, 2008, Jack is assigned 10 points for launching a web mail, 20 points for sending sensitive data as an attachment, and 5 points for sending an email. The risk score 1 602a of all the above tracked activities is 35. The assigned points undergo a first level modification based on the sequence of the tracked activities to generate a risk score 2 602b. As exemplarily illustrated in FIG. 9C, the activities comprising launching the web mail, sending sensitive data as an attachment, and sending the email form a predefined sequence of tracked activities and Jack is assigned 500 points for the sequence. The risk score 2 602b after the first level modification based on the sequence of tracked activities is 500.

Consider another example of Jack's tracked activities as illustrated in FIG. 11E. For Jack's activities on Apr. 5, 2008, Jack is assigned 10 points for launching a web browser, 20 points for downloading a file and storing the file locally, 10 points for browsing a different website, and 10 points for running an application. The risk score 1 602a of all the above tracked activities is 50. The assigned points undergo a first level modification based on the sequence of the tracked activities to generate a risk score 2 602b. As exemplarily illustrated in FIG. 9C, the activities of launching a web browser, downloading the file and storing the file locally, and running the application form a predefined sequence and Jack is assigned 500 points for the sequence. The risk score 2 602b after the first level modification based on the sequence of tracked activities is 510.

Consider another example of Jack's tracked activities as illustrated in FIG. 11F. For Jack's activities on Apr. 6, 2008, Jack is assigned 10 points for inserting a USB storage device, 5 points for copying “wave file 1” from the desktop to the USB storage device, 5 points for renaming file 1 from a protected folder, 5 points for renaming the file 2 from the protected folder, 5 points for copying file 1 to the USB storage device, 5 points for copying file 2 to the USB storage device, and 10 points for removing the USB storage device from the desktop. The risk score 1 602a of all the above tracked activities is 45. The assigned points undergo a first level modification based on the sequence of the tracked activities to generate a risk score 2 602b. As exemplarily illustrated in FIG. 9C, the activities insertion of the USB storage device, renaming the files from the protected folder, copying the files into the USB storage device, and removal of the USB storage device form a predefined sequence and Jack is assigned 350 points for the sequence. The risk score 2 602b after the first level modification based on the sequence of tracked activities is 355.

Consider another example of Jack's tracked activities as illustrated in FIG. 11G. For Jack's activities on Apr. 7, 2008, Jack is assigned 10 points for inserting a USB storage device, 5 points for launching word application, 5 points for sending an instant message (IM) application using Skype, 5 points for launching outlook, 5 points for copying file 1 to the USB storage device, 5 points for copying file 2 to the USB storage device, and 10 points for removing the USB storage device. The risk score 1 602a of all the above tracked activities is 45. The assigned points undergo a first level modification based on the sequence of the tracked activities to generate a risk score 2 602b. According to FIG. 9C, the activities comprising insertion of the USB storage device, copying files to the USB storage device and removal of the USB storage device form a predefined sequence and Jack is assigned 150 points for the sequence. The risk score 2 602b after the first level modification based on the sequence of tracked activities is 155.

Consider an example of Jack's tracked activities as illustrated in FIG. 11H. For Jack's activities on Apr. 8, 2008, Jack is assigned 10 points for launching “services.msc”, 10 points for stopping the antivirus service, 5 points for launching instant messaging (IM) application using Skype, 5 points for launching the outlook application, 10 points for downloading attachments using peer-to-peer (P2P) application, 10 points for restarting the antivirus service, and 10 points for launching the web browser. The risk score 1 602a of all the above tracked activities is 60. The assigned points undergo a first level modification based on the sequence of the tracked activities to generate a risk score 2 602b. As exemplarily illustrated in FIG. 9C, the activities launching the “services.msc” file, stopping the antivirus service, launching the outlook application, downloading from the p2p application, and restarting the antivirus service form a predefined sequence and Jack is assigned 200 points. The risk score 2 602b after the first level modification based on the sequence of tracked activities is 220.

Consider an example of Jack's tracked activities as illustrated in FIG. 11H. For Jack's activities on Apr. 9, 2008, Jack is assigned 15 points for launching a document from a protected folder, 10 points for doing a clipboard activity, 5 points for launching the web browser, 5 points for composing a new mail, 5 points for launching notepad, 10 points for pasting into the notepad, and 5 points for saving the file to the local drive. The risk score 1 602a of all the above tracked activities is 55. The assigned points undergo a first level modification based on the sequence of the tracked activities to generate a risk score 2 602b. As exemplarily illustrated in FIG. 9D, the activities of launching a document from a protected folder, doing a clipboard activity, pasting into notepad, and saving the file on a local drive form a predefined sequence of tracked activities and therefore Jack is assigned 500 points for the sequence. The risk score 2 602b after the first level modification based on the sequence of tracked activities is 515.

Consider an example of Jack's tracked activities as illustrated in FIG. 11J. For Jack's activities on Apr. 10, 2008, Jack is assigned 5 points for launching word application, 10 points for doing a clipboard activity, 5 points for saving the file to a local drive, 2 points for composing a new mail, 5 points for launching add or remove programs, 10 points for uninstalling software, and 5 points for launching the web browser. The risk score 1 602a of all the tracked activities is 42. The assigned points undergo a first level modification based on the sequence of the tracked activities to generate a risk score 2 602b. In the first level modification, the activities comprising launching add or remove programs and uninstalling software form a predefined sequence of tracked activities and therefore Jack is assigned 200 points for the sequence. The risk score 2 602b after the first level modification based on the sequence of tracked activities is 227.

Consider an example of Jack's tracked activities as illustrated in FIG. 11K. For Jack's activities on Apr. 11, 2008, Jack is assigned 5 points for launching word application, 10 points for doing a clipboard activity, 5 points for saving the file to a local drive, 2 points for composing a new mail, 5 points for launching add or remove programs, 10 points for installing software, and 5 points for launching the web browser. The risk score 1 602a of all the tracked activities is 42. The assigned points undergo a first level modification based on the sequence of the tracked activities to generate a risk score 2 602b. In the first level modification, the activities launching add or remove programs and installing software form a predefined sequence of tracked activities and therefore Jack is assigned 200 points for the sequence. The sequence of these tracked activities together are given higher points as these sequence of tracked activities pose a higher threat to organization's information. The risk score 2 602b after the first level modification based on the sequence of tracked activities is 227.

The assigned points obtained after first level of modification, for example, undergo the second level modification 802 based on a different predefined rule 601a, 601b, 601c, or 601d associated with the date and time of the tracked activities. For example, if Jack downloads a file from the web on a weekend, the assigned points obtained for downloading the file is modified based on the points associated with the date and time of the tracked activities.

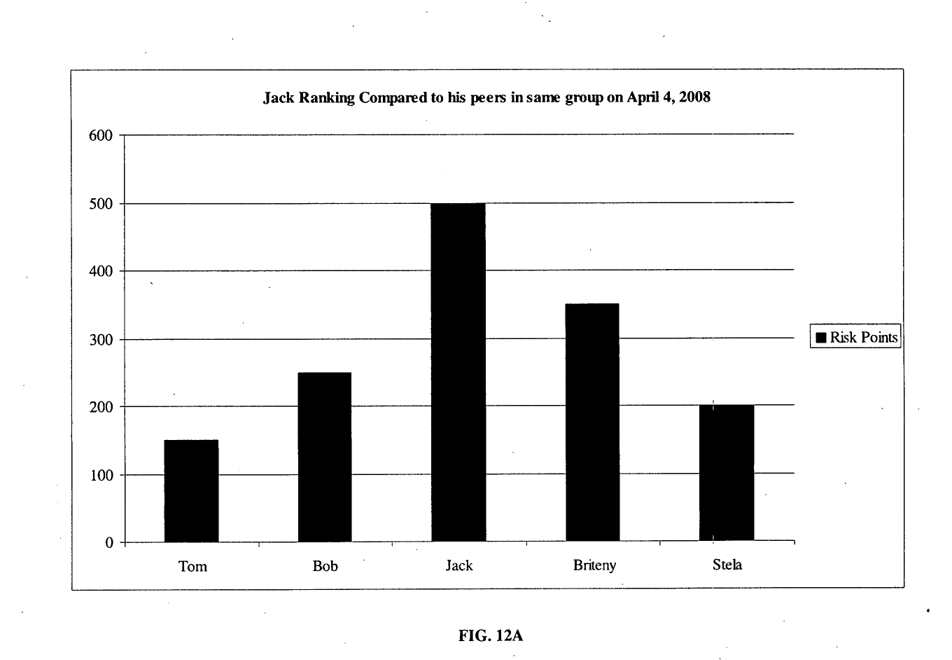

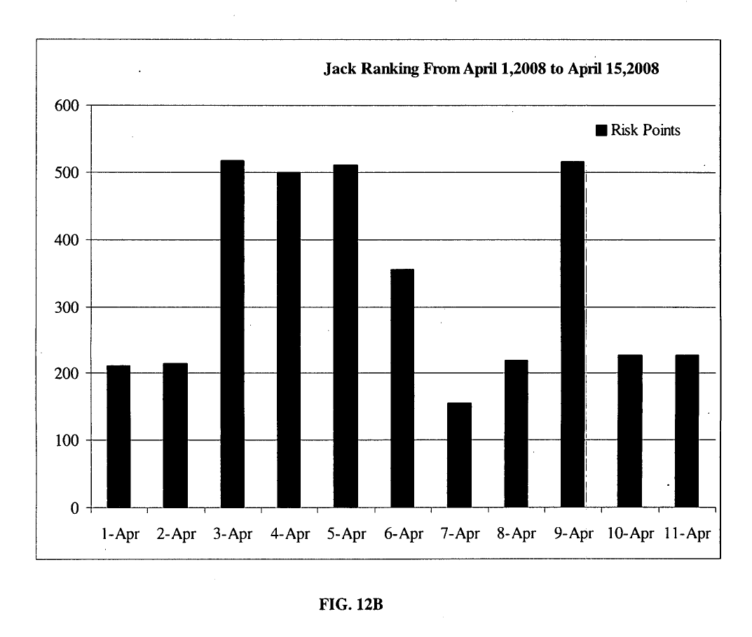

The assigned points after the second level modification, for example, undergo incremental levels of modification based on a different predefined rule associated with, for example, quantity and type of data or files associated with the activity, etc. before generation of the end risk score. For example, if Jack exceeds a download threshold then the assigned points are further modified based on the predefined rules. The system 200 then displays 505 a report comprising Jack's end risk score. Danny, on viewing the displayed report, is enabled to identify the risk involved in Jack's usage of the organization's IT resources, as well as identify any violations of the security policies by Jack. Danny requests the system 200 to calculate the deviation of Jack's present end risk score with a previously stored end risk score. The calculated deviation of the end risk score of Jack enables identification of trends of the risk involved in Jack's IT usage. The comparison of Jack's present end risk score with his previous end risk scores are displayed to Danny graphically as exemplarily illustrated in FIG. 12B. From the comparison, Danny observes that Jack's activities were of highest risk on the 3^{rd}, 4^{th}, 5^{th}, and 9^{th} of April, and that the risks on the other days were considerably lower. Danny can use this information to investigate the reason for the high risk activities on the particular days.

Danny then compares Jack's end risk score with the end risk scores of his peers to determine any deviation from the activities of his peers in the same group on the same day, for example, Apr. 4, 2008. The comparison of Jack's end risk score with the end risk scores of his peers are displayed to Danny graphically as exemplarily illustrated in FIG. 12A. From the comparison, Danny observes that Jack's activities on Apr. 4, 2008 had a much higher risk involved than the activities of his peers on the same day. He also sees that Tom's activities involved the least risk among Jack's peers on that day. Danny can use the observations to warn Jack of the high risk level associated with his activities.

Furthermore, Danny requests the system 200 to compare the generated end risk score with the threshold range of Jack's associated group risk ranking profile to determine the proximity of Jack's end risk score to the threshold range, for identifying and determining the level of violation of the security policies by Jack.

A list comprising different threshold ranges associated with different group risk ranking profiles based on organization and department is exemplarily illustrated in FIG. 13A and FIG. 13B respectively. Similarly, Danny also generates a report comprising the end risk scores of all the users 205 in the department. The users 205 with high end risk scores are identified from the report. The displayed report, for example, shows top violators of the security policies in the organization. The threshold values or ranges are defined so alerts can be generated from the system 200 to notify the administrators and management of violations that pose risks to the organization.

It will be readily apparent that the various methods and algorithms described herein may be implemented in a computer readable medium appropriately programmed for general purpose computers and computing devices. Typically a processor, for e.g., one or more microprocessors will receive instructions from a memory or like device, and execute those instructions, thereby performing one or more processes defined by those instructions. Further, programs that implement such methods and algorithms may be stored and transmitted using a variety of media, for e.g., computer readable media in a number of manners. In one embodiment, hard-wired circuitry or custom hardware may be used in place of, or in combination with, software instructions for implementation of the processes of various embodiments. Thus, embodiments are not limited to any specific combination of hardware and software. A “processor” means any one or more microprocessors, Central Processing Unit (CPU) devices, computing devices, microcontrollers, digital signal processors or like devices. The term “computer-readable medium” refers to any medium that participates in providing data, for example instructions that may be read by a computer, a processor or a like device. Such a medium may take many forms, including but not limited to, non-volatile media, volatile media, and transmission media. Non-volatile media include, for example, optical or magnetic disks and other persistent memory volatile media include Dynamic Random Access Memory (DRAM), which typically constitutes the main memory. Transmission media include coaxial cables, copper wire and fiber optics, including the wires that comprise a system bus coupled to the processor. Common forms of computer-readable media include, for example, a floppy disk, a flexible disk, hard disk, magnetic tape, any other magnetic medium, a Compact Disc-Read Only Memory (CD-ROM), Digital Versatile Disc (DVD), any other optical medium, punch cards, paper tape, any other physical medium with patterns of holes, a Random Access Memory (RAM), a Programmable Read Only Memory (PROM), an Erasable Programmable Read Only Memory (EPROM), an Electrically Erasable Programmable Read Only Memory (EEPROM), a flash memory, any other memory chip or cartridge, a carrier wave as described hereinafter, or any other medium from which a computer can read. In general, the computer-readable programs may be implemented in any programming language. Some examples of languages that can be used include C, C++, C#, or JAVA. The software programs may be stored on or in one or more mediums as an object code. A computer program product comprising computer executable instructions embodied in a computer-readable medium comprises computer parsable codes for the implementation of the processes of various embodiments.

Where databases are described such as the policy database 202a, the log database 203j, the rule database 203k, and the group risk ranking profile database 203l, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats including relational databases, object-based models and/or distributed databases could be used to store and manipulate the data types described herein. Likewise, object methods or behaviors of a database can be used to implement various processes, such as the described herein. In addition, the databases may, in a known manner, be stored locally or remotely from a device that accesses data in such a database.

The present invention can be configured to work in a network environment including a computer that is in communication, via a communications network, with one or more devices. The computer may communicate with the devices directly or indirectly, via a wired or wireless medium such as the Internet, Local Area Network (LAN), Wide Area Network (WAN) or Ethernet, Token Ring, or via any appropriate communications means or combination of communications means. Each of the devices may comprise computers, such as those based on the Intel® processors, AMD® processors, UltraSPARC® processors, Sun® processors, IBM® processors, etc. that are adapted to communicate with the computer. Any number and type of machines may be in communication with the computer.

The foregoing examples have been provided merely for the purpose of explanation and are in no way to be construed as limiting of the present invention disclosed herein. While the invention has been described with reference to various embodiments, it is understood that the words, which have been used herein, are words of description and illustration, rather than words of limitation. Further, although the invention has been described herein with reference to particular means, materials and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may effect numerous modifications thereto and changes may be made without departing from the scope and spirit of the invention in its aspects.

I claim:

1. A computer implemented method of determining risk involved in activities performed by a user of resources of an organization, comprising the steps of:
creating a plurality of group risk ranking profiles and security policies for usage of said resources of said organization, wherein said user is associated with one or more of said group risk ranking profiles;
tracking activities of the user in the organization by a security client application provided on a computing device of the user;
generating an end risk score for the user for each of said associated group risk ranking profiles, comprising the steps of:
assigning points to said tracked activities of the user based on each of the associated group risk ranking profiles, wherein said assigned points are aggregated to generate a first risk score; and
modifying said assigned points of the tracked activities of the user at different levels based on a plurality of predefined rules, wherein said modified points are aggregated to generate said end risk score;
whereby said generated end risk score determines said risk involved in said activities performed by the user in the organization.

2. The computer implemented method of claim 1, wherein the generated end risk score is used for identifying violations of said security policies of the organization by the user.

3. The computer implemented method of claim 1, wherein each of the group risk ranking profiles comprises a threshold range, wherein the end risk score of the user is compared with said threshold range for identifying violations and deviations from said security policies by the user.

4. The computer implemented method of claim 1, wherein said predefined rules are associated with type of the tracked activities, one of sequence and patterns of the tracked activities, date and time of the tracked activities, and quantity and type of data associated with the tracked activities.

5. The computer implemented method of claim 1, wherein said step of modifying the assigned points at said different levels comprises one or more of the steps of:
modifying the assigned points at a first level based on one of sequence and patterns of the tracked activities;
modifying the assigned points at a second level based on date and time of the tracked activities; and
modifying the assigned points at a third level based on quantity of data and type of data associated with the tracked activities.

6. The computer implemented method of claim 1, further comprising the step of selecting a time frame for generating the end risk score of the user, wherein the end risk score is generated for said selected time frame.

7. The computer implemented method of claim 1, further comprising the step of storing the tracked activities and the generated end risk score of the user in a log database.

8. The computer implemented method of claim 1, further comprising the step of calculating deviation of the generated end score of the user from one or more previously generated end risk scores of the user for a selected time frame for identifying violations of said security policies by the user.

9. The computer implemented method of claim 1, further comprising the step of displaying a report comprising the generated end risk score of the user for each of the associated group risk ranking profiles.

10. A computer implemented system for determining risk involved in activities performed by a user of resources of an organization, comprising:
a security client application on a computing device of said user, wherein said security client application comprises a tracking module for tracking activities of the user in said organization;
a risk management server comprising:
a group risk ranking profile creation module for creating a plurality of group risk ranking profiles and security policies for usage of said resources of the organization, wherein the user is associated with one or more of said group risk ranking profiles;
a scoring engine for generating an end risk score for the user for each of said associated group risk ranking profiles, where said scoring engine comprises:
a points assignment module for performing the steps of:
assigning points to said tracked activities of the user based on each of the associated group risk ranking profiles; and
modifying said assigned points of the tracked activities of the user at different levels based on a plurality of predefined rules; and
a score aggregation module for aggregating said points assigned to the tracked activities of the user to generate a first risk score, and for aggregating said modified points to generate said end risk score;
whereby said generated end risk score determines said risk involved in said activities performed by the user in the organization.

11. The computer implemented system of claim 10, wherein said scoring engine further comprises a rule engine for applying said predefined rules to the tracked activities, wherein the predefined rules are associated with type of the tracked activities, one of sequence and patterns of the tracked activities, date and time of the tracked activities, and quantity and type of data associated with the tracked activities, wherein the predefined rules are stored in a rule database of said risk management server.

12. The computer implemented system of claim 10, wherein said risk management server further comprises a log database for storing the tracked activities and the generated end risk score of the user.

13. The computer implemented system of claim 10, further comprising a policy server comprising a policy database for storing said security policies of the organization for users and user groups of the organization.

14. The computer implemented system of claim 10, further comprising a graphical user interface for enabling an administrator to create the group risk ranking profiles and said security policies.

15. The computer implemented system of claim 10, wherein said risk management server further comprises a selection module for enabling an administrator to select a time frame for generating the end risk score of the user using a graphical user interface, wherein said score aggregation module generates the end risk score for said selected time frame.

16. The computer implemented system of claim 10, wherein said risk management server further comprises a display module for displaying a report comprising the generated end risk score of the user for each of the associated group risk ranking profiles on a graphical user interface.

17. The computer implemented system of claim 10, wherein said risk management server further comprises a group risk ranking profile database for storing said created group risk ranking profiles.

18. The computer implemented system of claim 10, wherein said risk management server further comprises a comparison module for comparing the end risk score of the user with a threshold range associated with each of the group risk ranking profiles for identifying violations of said security policies by the user.

19. The computer implemented system of claim 10, wherein said risk management server further comprises a deviation module for calculating deviation of the generated end score of the user from one or more previously generated end risk scores of the user for a selected time frame for identifying violations of said security policies by the user.

20. The computer implemented system of claim 10, wherein said points assignment module performs one or more of the steps of:
modifying the assigned points at a first level based on one of sequence and patterns of the tracked activities;
modifying the assigned points at a second level based on date and time of the tracked activities; and
modifying the assigned points at a third level based on quantity of data and type of data associated with the tracked activities.

21. A computer program product comprising computer executable instructions embodied in a computer-readable medium, wherein said computer program product comprises:
a first computer parsable program code for creating a plurality of group risk ranking profiles and security policies for usage of resources of an organization;
a second computer parsable program code for providing a security client application on a computing device of a user;
a third computer parsable program code for tracking activities of said user in said organization using said security client application;
a fourth computer parsable program code for assigning points to said tracked activities of the user based on each of the associated group risk ranking profiles;
a fifth computer parsable program code for aggregating said assigned points to generate a first risk score; and
a sixth computer parsable program code for modifying the assigned points of the tracked activities of the user at different levels based on a plurality of predefined rules, wherein said modified points are aggregated to generate an end risk score, wherein said generated end risk score is used to determine risk involved in activities performed by the user in the organization.
